(19) United States
(12) Patent Application Publication
(10) Pub. No.: US 2010/0043187 A1
(43) Pub. Date: Feb. 25, 2010

(54) Multi-component funeral urn structure

(76) Inventors: Werner Steuer, Darmstadt (DE); Karen Venita Hay-Steuer, Darmstadt (DE)

Correspondence Address: DONN K. HARMS;PATENT & TRADEMARK LAW CENTER, SUITE 100, 12702 VIA CORTINA, DEL MAR, CA, 92014, US

(21) Appl. No.: 12/229,096

(22) Filed: Aug. 19, 2008

(51) Int. Cl. A61G 17/08

(52) U.S. Cl. 27/1

(57) ABSTRACT

A funeral urn formed of a plurality of component urns adapted to engage with each other in a cooperative engagement. The urn structure formed of the engaged component urns has a first visual appearance. Each of the component urns, when not cooperatively engaged with another component urn, has a second visual appearance distinct from the first visual appearance of the urn structure. Cooperative engagement of all of the component urns to form the urn structure provides a visual cue to viewers of the formed urn structure, that all of a plurality of individuals whose ashes are held in the component urns are deceased such as with an urn structure formed of two component urns housing the ashes of a deceased husband and wife.

### FIELD OF THE INVENTION

The disclosed device relates to funeral urn structures. More particularly it relates to a device and method providing two or more substantially identically shaped funeral component urns which are cooperatively engageable into an assembled urn structure having a totally different shape.

### BACKGROUND OF THE INVENTION

In modern times, the cost of funerals has risen proportionally with the cost of land for cemeteries and the costs involved in the funeral process. Further, in many areas of the world, land is at such a premium that cemeteries are being moved or built over.

As a consequence, there is an ever increasing popularity of employing cremation as a more cost-effective and ecological manner for the final handling of the deceased party. However, the process of cremation has its own requirements, one being a funeral urn for the final resting place and/or storage of the ashes of the deceased.

Such urns have developed over the years to many shapes and designs. Some of these designs are dependent on the final positioning of the remains of the deceased. If to be placed in a home occupied by a family, the urns may have one simple shape, and if to remain on public display, the urns may have a more decorative or ceremonial shape.

With the broadening employment of cremation by the public for such financial and ecological reasons, it has become ever more popular for persons making their funeral arrangements to purchase their urns in advance. Also popular is for couples such as a husband and wife, or two people who are particularly close, to choose urns which will allow for both their respective remains to be held together for eternity.

Generally such joint-use urns have a plurality of individual compartments in a single urn unit. This allows one compartment to be occupied by the remains of the first person of the pair to expire while the other of the two remains earthbound and awaits a subsequent fate. Such future-use urns may be displayed in the home for other family members and friends to view while awaiting the passage of one or both of the intended parties.

Current art in urn design, however, generally provides no additional utilitarian or decorative functions for such multi-occupant urns. They are simply a unitary structure having two or more cavities within for final resting of the remains of the deceased. Consequently, they serve no other purpose while the intended parties are still earthbound. Still further, they only have one set of dimensional characteristics and the urn thus appears and is viewed as a single device in a single fashion. Thus, people viewing the multi-occupant urn have no manner to discern if one or both parties have expired since there is no change in appearance upon the death of the second of the two parties to expire.

As such, there exists an unmet need for an urn device which has multiple compartments for ashes of the deceased and also has two modes of appearance to viewers, depending on whether one or more of the parties intended for final resting in the urn are deceased. Such a device should have one appearance when only one party is deceased, and be capable of a second, completely different, appearance upon the death of the second party intended for the urn. Further, such an urn device should ideally be capable of a secondary function while the urn components remain separate to provide a more decorative and utilitarian urn device that may be displayed in a home or columbarium.

In this respect, before explaining at least one embodiment of the invention herein and method or employment in detail, it is to be understood that the invention is not limited in its application to the details of construction and to the arrangement of the components set forth in the following description or illustrated in the drawings nor the steps outlined in the specification. The invention is capable of other embodiments and of being practiced and carried out in various ways as those skilled in the art will readily ascertain from reading this application. Also, it is to be understood that the phraseology and terminology employed herein are for the purpose of description and should not be regarded as limiting.

As such, those skilled in the art will appreciate that the conception upon which this disclosure is based may readily be utilized as a basis for designing other methods and systems for carrying out the several purposes of the present invention of a device which is a significant improvement to funeral urns in both appearance and function. It is important, therefore, that the claims be regarded as including such equivalent construction insofar as they do not depart from the spirit and scope of the present invention.

### OBJECTS OF THE INVENTION

An object of this invention is the provision of a multi-component funeral urn structure for employment to provide the final resting place for two or more individuals.

An additional object of this invention is the provision of such an urn structure which has one visual appearance when both component urns are holding the ashes of both parties and a second, totally different appearance when only one urn component is occupied prior to the death of both parties. Thereby providing a visual cue to third parties as to whether both individuals have passed on or not.

Yet another object of this invention is to provide such an urn structure that is formed of two substantially identically shaped component urns which yield a first mode of appearance to third parties.

A further object of this invention is the provision of such an urn structure formed of two substantially identically shaped component urns which have a first appearance when cooperatively engaged, and a second, totally different shape and appearance when separated.

A still further object of this invention is the provision of such a funeral urn structure, which in the separated state, provides another use or function other than visual decoration.

These together with other objects and advantages which will become subsequently apparent reside in the details of the construction and operation of the urn device herein as more fully hereinafter described and claimed, reference being had to the accompanying drawings forming a part thereof, wherein like numerals refer to like parts throughout.

### SUMMARY OF THE INVENTION

The device herein and method of employment thereof, provide an assembled urn structure formed of two or more substantially identically dimensioned component urns. Each of the plurality of component urns appears visually to be a totally different shape from the urn structure formed by cooperative engagement of the plurality of components with each other.

In a particularly preferred mode of the device and method herein, the assembled urn structure has two compartments to house the ashes of two different individuals such as a husband and wife upon their death. The assembled urn structure has an appearance that is defined by the cooperative engagement of two substantially identical component urns into the final assembled urn structure. The two individual component urns, however, have different dimensional characteristics from the assembled urn structure, and therefore appear visually in a totally different shape. This design allows for the device to be separated prior to the death of both individuals employing the assembled urn structure and provides a means for a visual cue to third parties that both individuals have not passed on as of yet. However, once both parties have passed on and have been positioned in a respective compartment of each of the two component urns, the assembled urn structure may be assembled by cooperative engagement of the two component urns to form a totally different shape from that of the individual component urns. So assembled, the device provides a means to visually cue third parties that both of the urn occupants have passed on and rest in peace together.

Of course, the assembled urn structure might be cooperatively engageable from more than two individual component urns. Should a family or group of individuals of some relation wish to all occupy the multi-component urn, a plurality of components of substantially identical appearance individually can be provided to match the number of occupants for the assembled urn structure. The plurality would each have one appearance prior to assembly of the assembled urn structure. Then, once so assembled, the assembled urn structure would have a totally different appearance to provide both a decorative function and a visual cue to third parties whether all the parties have passed on or not. In this mode, the individual component urns may also be assembled one by one wherein the assembled urn structure would not assume the final state of appearance until all the component urns are engaged. However, the assembled urn structure would have a number of individual appearance states dependent on how many of the individual component urns have been engaged. This staged assembly would provide a visual cue to people seeing the individual component urns as to how many of the plurality have passed on and how many continue to live on.

Additionally preferred in the favored mode of the device and method, the plurality of component urns should have a second function other than just providing a visual cue as to the state of being of the individuals intended for the component urns. This would encourage display of the individual components and would provide a less dreary connotation to the individual components. Consequently, the individual components to the assembled urn structure would have surfaces adapted to engage with other items and provide a display or base for those items.

Particularly preferred is the employment of the individual component urns to hold candles. This would allow their employment as candleholders at the funeral of the first to expire and also as candleholders prior to their assembly to the ultimate assembled urn structure.

Another particularly preferred mode of the device herein is the employment of the plurality of component urns as plant holders for either artificial or live plants. This is easily accomplished by providing recesses in the exterior surface of the individual component urns that are adapted for holding plants. The recesses, however, would disappear when the components are assembled into the assembled urn structure. Like the candleholder option, this mode of the device allows the individual components to be employed for a different use prior to their assembly into the assembled urn structure, thereby encouraging their purchase and use since, unlike conventional urns which simply take up a spot on the mantle, the individual components provide a decorative and utilitarian function and a real conversation piece.

With respect to the above description then, it is to be realized that the optimum dimensional relationships for the parts of the invention, to include variations in size, materials, shape, form, function, manner of operation, and assembly and use, are deemed readily apparent and obvious to one skilled in the art. Consequently, all equivalent relationships to those illustrated in the drawings and described in the specification are intended to be encompassed by the present invention. Therefore, the foregoing description and following detailed description are considered as illustrative only of the principles of the invention. Further, since numerous modifications and changes will readily occur to those skilled in the art, it is not desired to limit the invention to the exact construction, appearance, and operation shown and described. Accordingly, all suitable modifications and equivalents which may be resorted to are considered falling within the scope of the invention.

### BRIEF DESCRIPTION OF THE DRAWINGS

FIG. 1 shows a perspective view of the device assembled to the multi-component assembled urn structure, which has a first visual appearance.

FIG. 2 depicts a plurality of two substantially identically shaped component urns separated and having a second visual appearance from that of the assembled urn structure formed by their cooperative engagement.

FIG. 3 depicts the device wherein the individual component urn additionally has a compartment or structural component to allow function as a plant holder.

FIG. 4 depicts the device wherein the individual component urn additionally has a compartment or structural component to allow function as a candle holder.

FIG. 5 depicts another plurality of individual component urns adapted for mutual engagement to an assembled urn structure.

FIG. 6 depicts an assembled urn structure appearance formed by the cooperative engagement of the component urns of FIG. 5.

FIG. 7 depicts another plurality of individual component urns adapted for mutual engagement to an assembled structure.

FIG. 8 depicts the assembled urn structure having a different visual appearance from that of its disassembled component urns from FIG. 7.

FIG. 9 depicts a plurality of component urns which are photo frames.

FIG. 10 depicts the assembled urn structure of FIG. 9.

FIG. 11 depicts an assembled urn structure formed of 8 component urns.

FIG. 12 is a component urn of FIG. 11.

FIG. 13 depicts an assembled urn structure from four component urns.

FIG. 14 is a depiction of one component urn of FIG. 13.

### DETAILED DESCRIPTION OF THE INVENTION

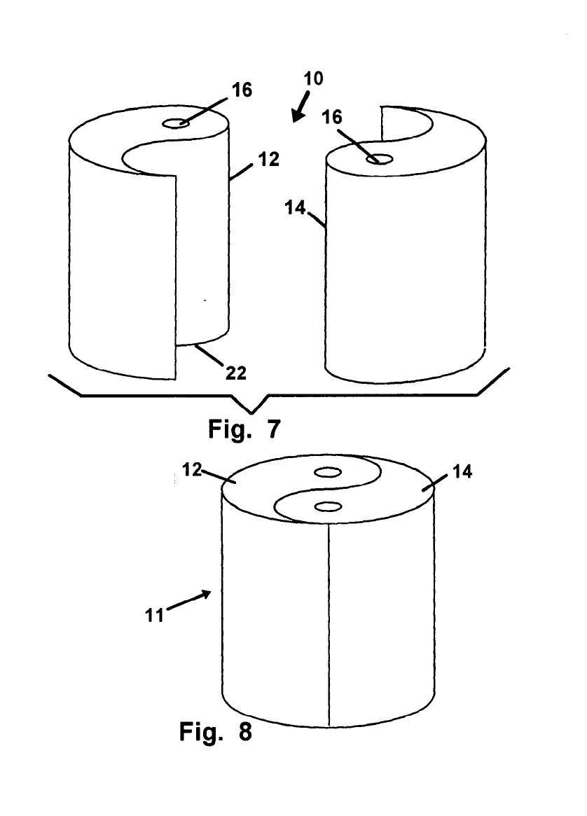

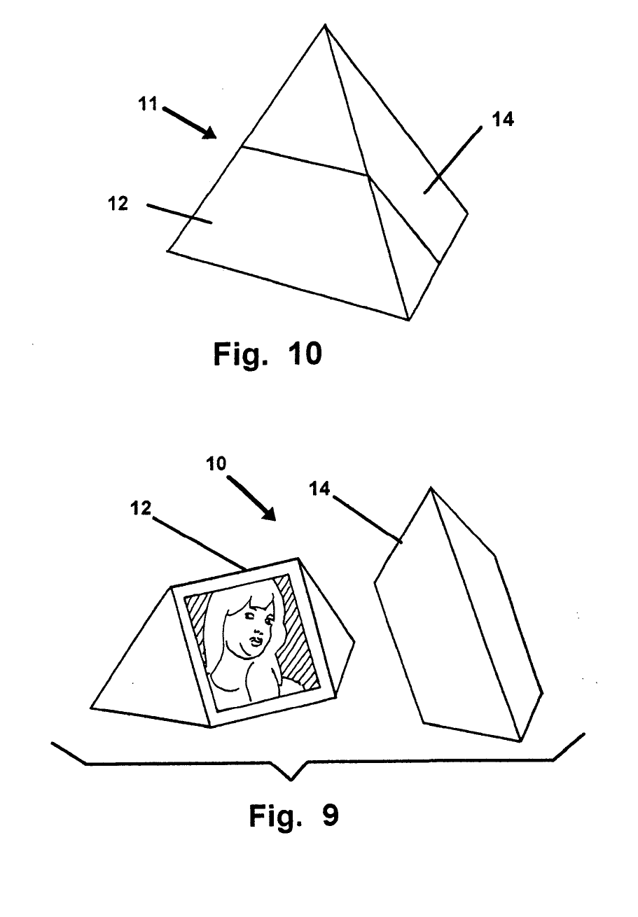

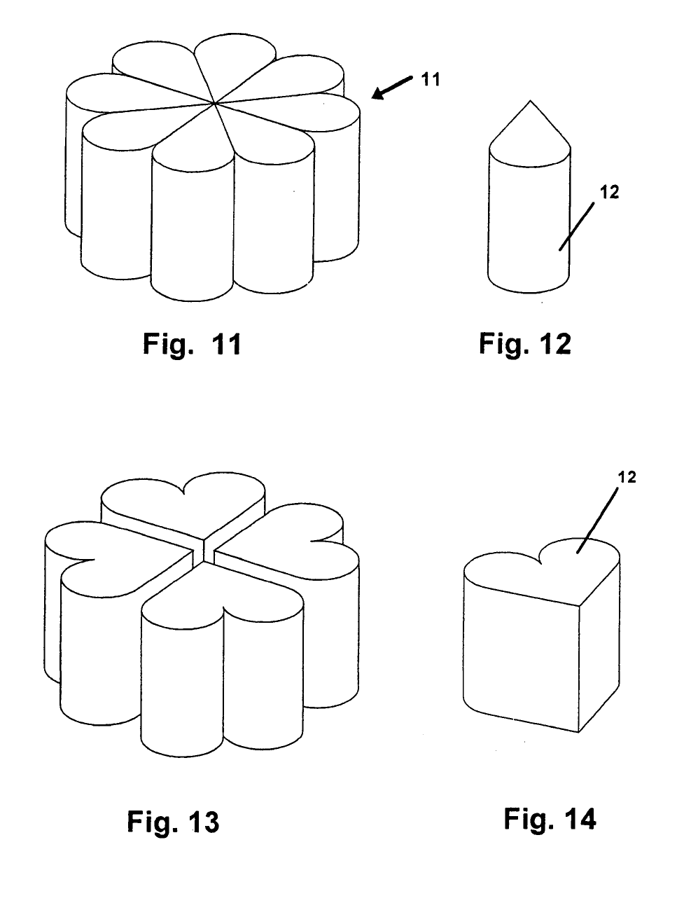

Referring now to the drawings in FIGS. 1-14, wherein similar parts are identified by like reference numerals, there is seen in FIG. 1 a perspective view showing an assembled urn structure 11 formed by the plurality of individual component urns 12 and 14. As shown, the assembled urn structure 11 has a first appearance visually which is different from a second visual appearance of each of the two component urns 12 and 14 as shown in FIG. 2. As noted, the different visual appearances of the substantially identically appearing component urns 12 and 14 from that of the assembled urn structure 11 provide a visual means to cue persons viewing the device 10 as to whether all the parties intended for the multiple compartments of the assembled urn structure 11 are deceased.

The component urns 12 and 14 may be formed of metal, ceramics, or other materials adapted to provide an accessible interior cavity (not shown) for final placement of the ashes of an individual. Generally, the interior cavity would be accessible through a sealable cover 22 (FIG. 2) which would be removable to allow placement of the ashes into the interior cavity, and once replaced would seal the interior cavity.

When assembled, the component urns thereby provide an assembled urn structure 11 having a plurality of individual sealed interior cavities. The depictions in FIGS. 1-10 show a plurality of two component urns 12 and 14 adapting the assembled urn structure 11 to hold in separate compartments the final remains of two individuals such as a husband and wife and is a particularly preferred mode of the device 10 herein. However, as noted, the component urns 12 and 14 might be a plurality of individual components of more than two, in which each such component urn, having substantially the same appearance while separated, will have a totally different appearance with its sequential engagement to the urn structure. A final appearance of the urn structure 11 different than the appearance of the individual component urns and different than each of the sequential appearances would be reached upon assembly of all of the component urns to the assembled urn structure 11.

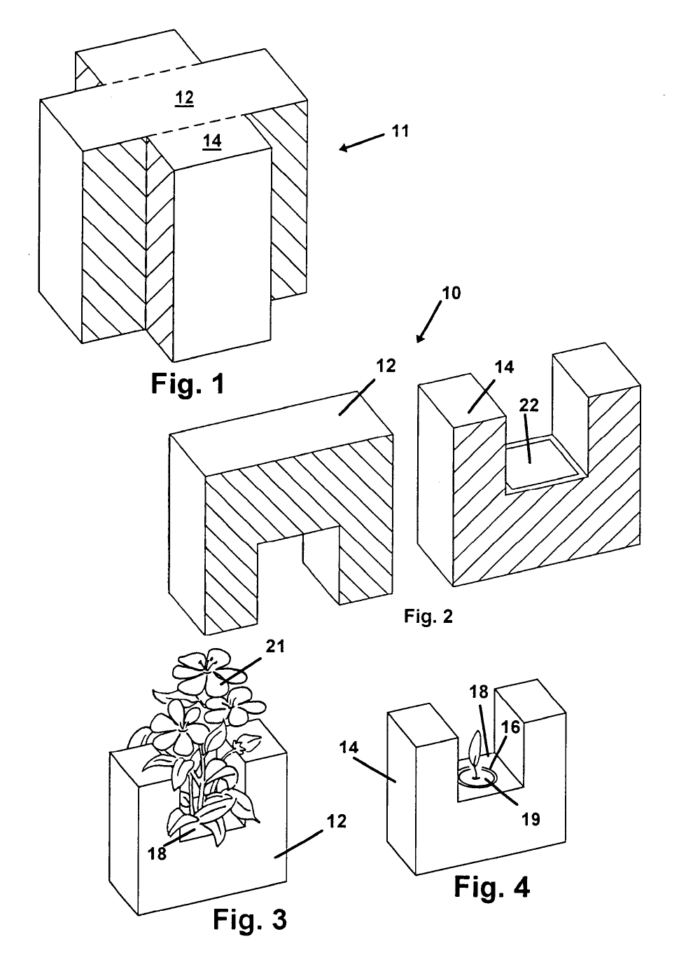

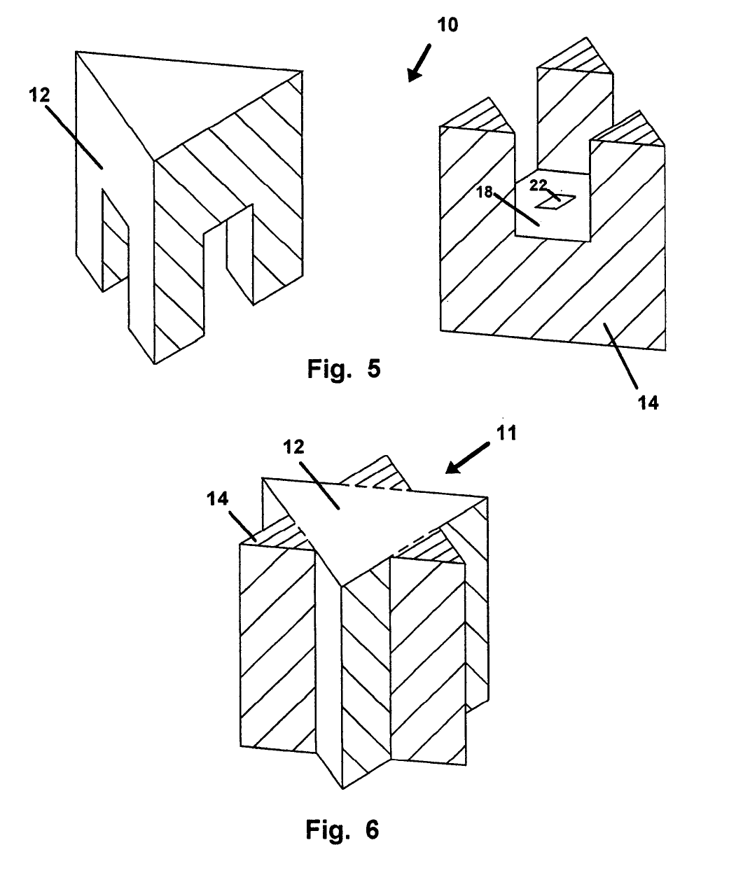

Additionally preferred in the favored mode of the device and method herein as shown in FIGS. 3 and 4, the component urns 12 and 14 will have a second utilitarian function other than just providing the resting place for a deceased's ashes and being a visual cue as to the state of being of the individuals intended for the assembled urn structure 11.

Particularly preferred is the employment of the individual component urns 12 and 14 as shown in FIGS. 3 and 4. A recess 16 may be provided to hold a candle 19 or a surface 18 as shown in FIG. 4 might provide the means to engage a candle 19 to the exterior surface of the component urns.

Another particularly preferred mode of the device 10 herein is the employment of the plurality of component urns as plant holders as shown in FIG. 3. A recess 16 may be provided to hold the plant 21 or a surface 18 to hold a planter for the plant 21 as shown in FIG. 3 might provide the means to engage a plant 21 on the exterior surface of the component urns.

The method and components shown in the drawings and described in detail herein disclose arrangements of elements of particular construction and configuration for illustrating preferred embodiments of the structure of the multi-component urn structure formed of a plurality of individual component urns. It is to be understood, however, that elements of different construction and configuration and using different steps and procedures and other arrangements thereof, other than those illustrated and described, may be employed for providing a multi-component urn for a plurality of deceased individuals' ashes in accordance with the spirit of this invention.

As such, while the present invention has been described herein with reference to particular embodiments thereof, a latitude of modifications, various changes and substitutions are intended in the foregoing disclosure, and it will be appreciated that in some instances some features of the invention could be employed without a corresponding use of other features, without departing from the scope of the invention as set forth in the following claims. All such changes, alterations and modifications as would occur to those skilled in the art are considered to be within the scope of this invention as broadly defined in the appended claims.

Further, the purpose of the abstract of the invention included in this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting, as to the scope of the invention in any way.

What is claimed is:

1. A funeral urn comprising:
a multi-component urn structure having a first visual appearance;
said multi-component urn structure formed of a plurality of component urns each adapted for a cooperative engagement with other said component urns from said plurality of component urns;
each said component urn having an internal cavity adapted to hold the ashes of a cremated deceased individual, said internal cavity accessible through a sealable cover;
each of said component urns when not in said cooperative engagement, having a substantially identical second visual appearance, said second visual appearance visually distinct from said first visual appearance; and
said component urns in said cooperative engagement thereby forming said urn structure having said first visual appearance.

2. The funeral urn of claim 1 wherein said first visual appearance provided by said component urns in said cooperative engagement provides a means for viewers of said funeral urn to ascertain a deceased status of all of a plurality of said deceased individuals whose ashes occupy a respective internal cavity of one of said component urns; and
said plurality of said individuals being a number equal to said plurality of component urns.

3. The funeral urn of claim 2 additionally comprising:
said plurality of component urns numbering two.

4. The funeral urn of claim 3 additionally comprising:
said plurality of component urns numbering two and said individuals being spouses.

5. The funeral urn of claim 2 additionally comprising:
each said component urns having a substantially U-shaped said second visual appearance; and
said funeral urn having a first visual appearance which appears substantially as a cross.

6. The funeral urn of claim 3 additionally comprising:
each said component urns having a substantially U-shaped said second visual appearance; and
said funeral urn having a first visual appearance which appears substantially as a cross.

7. The funeral urn of claim 2 additionally comprising:
an exterior surface on each said component urn, said exterior surface providing means for an engagement with a candle, wherein each said component urn functions as a candle holder when not in said cooperative engagement.

8. The funeral urn of claim 7 additionally comprising:
said means for engagement with said candle being a recess formed in said exterior surface.

9. The funeral urn of claim 2 additionally comprising:
an exterior surface on each said component urn, said exterior surface providing means for support of a plant thereon, wherein each said component urn functions as a plant holder.

10. The funeral urn of claim 9 additionally comprising:
said means for support of said plant provided by a recess formed in said exterior surface.

11. The funeral urn of claim 3 additionally comprising:
said second visual appearance of each said component urns being that of a triangular shaped body portion having three triangular shaped members extending therefrom; and
said funeral urn having a first visual appearance of a six pointed star.

12. The funeral urn of claim 3 additionally comprising:
said funeral urn formed of said component urns in said cooperative engagement having a first visual appearance of a cylinder.

13. The funeral urn of claim 3 additionally comprising:
said funeral urn formed of said component urns in said cooperative engagement having a first visual appearance of a tetrahedron.

14. The funeral urn of claim 2 additionally comprising:
said plurality of component urns numbering four;
said second visual appearance of each said component urns being heart shaped; and
said funeral urn formed by said component urns in said cooperative engagement having a first visual appearance of a cloverleaf.

15. The funeral urn of claim 2 additionally comprising:
said plurality of component urns numbering more than four; and
said funeral urn formed by said component urns in said cooperative engagement having a first visual appearance of a flower with petals.
